(19) United States
(12) Patent Application Publication
(10) Pub. No.: US 2005/0016209 A1
(43) Pub. Date: Jan. 27, 2005

(54) Coolant distributor

(76) Inventor: Zbigniew Ryszard Huelle, Hannover (DE)

Correspondence Address: SHLESINGER, ARKWRIGHT & GARVEY LLP, 3000 South Eads Street, Arlington, VA, 22202, US

(21) Appl. No.: 10/924,844

(22) Filed: Aug. 25, 2004

Related U.S. Application Data
(63) Continuation of application No. PCT/EP03/01541, filed on Feb. 15, 2003.

(30) Foreign Application Priority Data
Mar. 15, 2002 (DE) 102 11 477.3
Feb. 27, 2002 (DE) 102 08 471.4

(51) Int. Cl. F25B 41/06; F02M 25/07; F02B 47/08

(52) U.S. Cl. 62/527; 62/528

(57) ABSTRACT

Coolant distributor for use between an expansion valve and an evaporator of a refrigeration installation. Distributor includes a central fluid/vapour inflow channel, several outflow channels, which are distributed around the inflow channel and include inflow openings for the fluid and the vapour, a housing, a conduction chamber for radial flow conduction, and an annular chamber between the housing wall and the outflow channels, which acts as a collection chamber for the fluid and the vapour. The outflow channels include passages in the channel wall, the passages connecting the fluid and the vapour regions of the annular chambers to the channels. The coolant distributor is cost-effectively produced and adapted easily to respective coolants and their dynamic characteristics, in addition to obtaining a satisfactory coolant distribution. To achieve this, for example the coolant distributor may be provided with a one-piece distributor head, in which the outflow channels are configured and which includes a cap for controlling the inflow.

### CROSS-REFERENCE TO RELATED APPLICATIONS

This application is a continuation of U.S. application no. PCT/EP03/01541, filed Feb. 15, 2003, which claims the priority of German application no. 102 11 477.3, filed Mar. 15, 2002, and which U.S. application no. PCT/EP03/01541 claims the priority of German application no. 102 08 571.4, filed Feb. 27, 2002, and each of which is incorporated herein by reference.

### FIELD OF THE INVENTION

This invention relates to coolant distributors. More specifically, the invention relates to coolant distributors including a distributor head having outflow channels and a cap for intake control. Even more particularly, the invention relates to a coolant distributor particularly suited for use between coolant distributor for use between an expansion valve and an evaporator of a cooling system with a central fluid/gas mixture intake channel, multiple outflow channels distributed around the intake channel with intake openings for the fluid and the gas, a housing, a flow space for radial flow direction, a ring space between housing wall and outflow channels as collection space for the fluid and the gas. The outflow channels in the channel walls may have at least one passage connecting the fluid and gas region of the ring space with the channels, and a one-piece distributor head provided in which the outflow channels are provided, and which has a cap for intake control.

A cooling system works on the principle of a closed coolant circulation; see the attached FIGS. 1 and 2. The four main components of such a coolant circulation system are the evaporator, the compressor, the condenser with the collector, and the expansion valve. In the evaporator, heat is led to the coolant at a low temperature and correspondingly low pressure, which causes the two-phase mixture of fluid and gas introduced to the evaporator to transition into the gas phase. The liquid phase of the coolant absorbs heat (evaporation heat) during its transition into the gaseous phase (evaporation process) in an amount corresponding to this process.

In the compressor, the gaseous phase taken in at low temperature and correspondingly low pressure is compressed to a higher temperature and correspondingly higher pressure via the addition of work (work of compression).

In the condenser, the heat is removed from the gaseous phase at higher temperature and correspondingly higher pressure, and it transitions into the liquid phase by releasing condensing heat. The liquefied coolant is continually removed from the condenser and collected in the collector to be transported further. In the expansion valve, the liquid coolant is relaxed (throttled) from the higher pressure and correspondingly higher temperature in the condenser to the lower pressure and correspondingly lower temperature in the evaporator. This relaxation process is not loss-free. In the course of the relaxation process, a part of the liquid phase of the coolant evaporates, and the coolant transitions to the two-phase mixture liquid/gas, which is introduced into the evaporator.

If the evaporator consists of only a single length of pipe, that is, only one evaporation path exists, as shown in FIG. 1, then, no coolant distributor is necessary. This is, however, only a rare, exceptional case. In normal industrial practice, the evaporator consists of multiple evaporation paths, and a coolant distributor must be used to ensure the even distribution of the two-phase liquid/gas coolant mixture. The position of such a coolant distributor is shown in FIG. 2. As seen, the coolant distributor is directly connected over a single pipe with the expansion valve. From the coolant distributor, multiple lines lead further to the individual evaporation paths of the evaporator.

The two-phase mixture gas/liquid of the coolant is not homogeneous after the expansion valve. The mass proportions of gas and liquid in the mixture at the intake of the coolant distributor vary stochastically over time. For this reason, an even distribution for the purpose of even mass streams in the coolant into the evaporation paths is difficult.

The use of so-called Venturi distributors and Chawla/Schmitz distributors as coolant distributors is well-known; see DE 24 60 214, DE 27 31 279, DE 42 07 275, DE 44 07 275, as well as EP 360 034.

The Venturi distributor has the disadvantage that in the Venturi neck, the presumed homogenization of the two-phase mixture is not optimal, so that in practice an unsatisfactory coolant distribution is observed.

In distributor construction according to Chawla/Schmitz, an attempt is made to achieve the homogenization of the gas/liquid mixture by separation and subsequent remixing. The rigid mechanical construction designed for this purpose is, however, associated with to many inconveniences in operation and manufacture. The distributor has many solder and weld seams in difficult-to-reach places. The Chawla/Schmitz distributor allows no quick or cost-effective adjustment to the flow dynamics of the individual coolant groups.

An object of the present invention is to create a coolant distributor which is simply and cost-effectively manufactured, can easily be adapted to a respective coolant and its dynamic properties, in use, and which provides satisfactory coolant distribution.

This object is solved by the invention coolant distributor for use between an expansion valve and an evaporator of a cooling system according to the invention having a central fluid/gas mixture intake channel, multiple outflow channels distributed around the intake channel with intake openings for the fluid and the gas, a housing, and a flow space for radial flow direction. A ring space may be provided between housing wall and outflow channels as collection space for the fluid and the gas, by which the outflow channels in the channel walls have at least one passage connecting the fluid and gas region of the ring space with the channels, and a one-piece distributor head provided in which the outflow channels are provided and which has a cap for intake control.

Advantageous and purposeful additional embodiments of the invention which solve the problems set forth above include the following.

Coolant distributor according to the invention may include the housing having a cover connected to the distributor head, surrounding at least one part of the distributor head and the cap with a gap.

Coolant distributor according to the invention may include the intake channel having a cylindrical penetrating boring in the distributor head for the direction of the fluid/gas mixture from below, and an opening ending with a gap at the cover wall in which cap is inserted, and which has a continually widening cap channel directed towards the intake channel.

Coolant distributor according to the invention may include the intake channel including an intake nipple on the top of the housing or the cover, for the direction of the liquid/gas mixture from above, and the mushroom-shaped cap of the distributor head located below the intake channel having a closed convex upper surface against which the fluid/gas mixture flows.

Coolant distributor according to the invention may include the free rim of the cap covering the intake opening of the outflow channels with a gap.

Coolant distributor according to the invention may include the distributor head including an upper cylindrical part on which the cap is inserted, and a lower cone-shaped extension part.

Coolant distributor according to the invention may include the outflow channels run parallel to the intake channel in the upper part of the distributor head and slant outwards in the lower part of the distributor head.

Coolant distributor according to the invention may include the rim of the cover being connected with a ring flange of the distributor head.

Coolant distributor according to the invention may include the ring flange being located at the boundary between part and part of the distributor head.

Coolant distributor according to the invention may include at least one passage being located in the region of the outflow channel located in the cylindrical part.

Coolant distributor according to the invention may include the passages are slits manufactured by providing (e.g., by milling) surrounding grooves on the cylindrical part of the distributor head.

Coolant distributor according to the invention may include the surrounding grooves are extended outwards.

Coolant distributor according to the invention may include the edges of the surrounding ribs remaining between the surrounding grooves are rounded.

Coolant distributor according to the invention may include the passages are vertical slits or borings in the wall of the outflow channels next to the cylindrical part of the distributor head.

Coolant distributor according to the invention may include the outflow channels have a smaller free flow area than the intake channel.

Coolant distributor according to the invention may include the height and diameter of the cylindrical part of the distributor head, the height, width, and number of slits and the number and size of borings in the outflow channels, the length and diameter of the intake channel, and the height and width of the cover are variably selectable.

Coolant distributor according to the invention may include in the ring space of the coolant distributor there is a ring-shaped interior wall of a sieve-like, screen-like, or perforated plate material.

Coolant distributor according to the invention may include the interior wall ends with a gap at the wall of the housing or cover.

Coolant distributor according to the invention may include a permeable filling material being placed in the ring space.

Coolant distributor according to the invention may include the filling material being metal wool.

Coolant distributor according to the invention may include the interior wall and/or the filling material being located in the fluid region of the ring space.

Coolant distributor according to the invention may include the distributor head is manufactured by machining of stock or using a casting technique.

The inventive coolant distributor can basically be manufactured in two different variants or embodiments, the first with the intake of the gas/liquid mixture from below, and the other with intake of this mixture from above.

In the embodiment with intake of the mixture from below, the inventive coolant distributor includes only three parts; a distributor head, a cover welded to the distributor head, and a cap on the distributor head for control of the inflow. In the embodiment with intake of the mixture from above, the inventive coolant distributor includes substantially only four parts, namely a distributor head, a cover attached [e.g., welded] to the distributor head, a mushroom-shaped cap on the distributor, and an intake nipple attached [e.g., welded] into the cover.

The distributor head according to the invention can be manufactured from stock appropriate to the task, preferably of metal, completely using a turning/boring/milling machine, preferably fully automatically using a predeterminable program, or it can be manufactured using casting techniques. This provides an adaptable, cost-effective, and quick manufacture. The following parameters may be freely selected: length, diameter, and number of output channels, width, height, and number of passages, especially slits, in the output channels, and diameter and length of the intake channel.

The cover may also be a one-piece component, or can be, for production reasons, of two parts connected together, for example by welding, for example a lower cylindrical part and a domed upper part. The dimensions and shape (width, height, curvature) of the cover are easily adapted to the dimensions of the distributor head.

The inventive coolant distributor can thus be formed in its construction, as desired, so that it is adaptable to the relevant flow conditions of the gas/liquid mixture to optimize the even distribution of the gas/liquid mass flow of the relevant coolant.

In contrast to the well-known Chawla/Schmitz distributors, which are constructed on the basis of standard, off-the-shelf pipe dimensions, the construction of the inventive coolant distributor provides a quick and cost-effective adaptation of production to the existing requirements, in fact in connection with the current dynamic properties of the selected coolant group. Thus, as already noted, an even distribution of the gas/liquid mass flow of the coolant is achieved.

The invention is explained in more detail below with reference to the attached drawings, in which various embodiments are shown.

### BRIEF DESCRIPTION OF THE DRAWINGS

FIG. 1 shows a schematic diagram of a state-of-the-art coolant circuit without a coolant distributor;

FIG. 2 shows a schematic diagram of a state-of-the-art coolant circuit with a coolant distributor;

FIG. 3 shows a first embodiment of a coolant distributor according to the invention in cross-section with a distributor head, cover, and intake cap;

FIG. 3a shows a cross section A-A through the coolant distributor in FIG. 3;

FIG. 3b shows a section B-B through the coolant distributor in FIG. 3;

FIGS. 3c, 3d show two sections analogous to section B-B in FIG. 3b through distributor heads with a different number of output channels;

FIGS. 4a, 4b, 4c show three different distributor head constructions;

FIG. 5 shows a second embodiment of the inventive coolant distributor in cross-section;

FIG. 6 shows a third embodiment of the inventive coolant distributor in cross-section;

FIG. 7 shows the embodiment in FIG. 3 with a modified cover and weld seam;

FIG. 8 shows a modification of the embodiment in FIG. 3;

FIG. 8a shows a cross-section A-A through the embodiment in FIG. 8; and

FIG. 8b shows a cross-section B-B through the embodiment in FIG. 8.

Identical or corresponding components in the Figures of the drawing are labeled with the same reference numbers.

Relative terms such as up, down, left, and right are for convenience only and are not intended to be limiting.

### DETAILED DESCRIPTION OF THE INVENTION

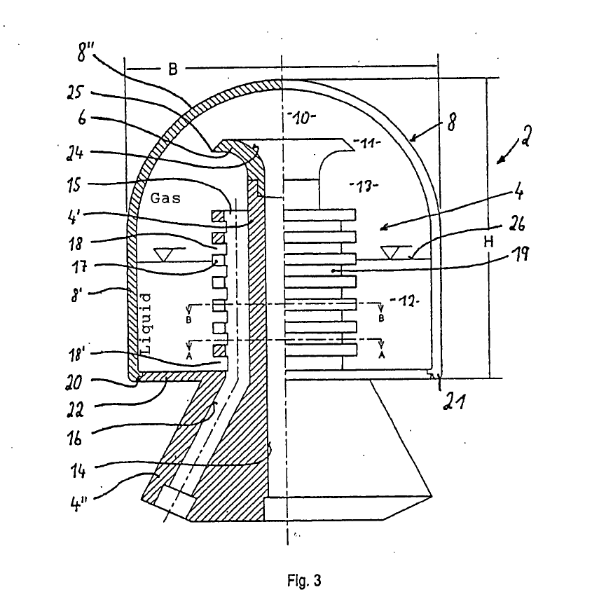

FIG. 3 shows a coolant distributor 2 including a distributor head 4, an intake cap 6, and a cover 8.

The distributor head 4 includes an upper cylindrical part 4′, on which the intake cap 6 is attached, and a lower cone-shaped extended part 4″, which may be constructed in a single piece with the cylindrical part 4′.

The cover 8 surrounds the cylindrical part 4′ with cap 6 with a gap, so that between the cylindrical part 4′ and the cap 6 on the one hand, and cover 8 on the other hand, an upper flow/guiding space 10 is formed for radial flow direction, then a ring-shaped flow space 11, then a ring chamber 13 and finally a ring space 12.

The distributor head 4 includes a central, vertical, round intake channel 14 through parts 4′ and 4″, and around this, multiple concentric evenly-distributed (round) outflow channels 16, see FIGS. 3a-3d, which run vertically and parallel to the central intake channel 14 in part 4′, and slanted outwards in lower part 4″, somewhat corresponding to the conical slope, and also possesses an inflow opening 15. The outflow channels 16 are connected in the upper part 4′ of the distributor head 4 over passages designed as slits 18 with the ring space 12, see also FIG. 3a. The slits 18 are preferably manufactured by cutting, for example milling, from surrounding grooves 19 in part 4′ of the distributor head 4, and are separated from one another by surrounding ribs 17.

In FIG. 3a, SB denotes a slit width, RFr a milling radius, and RVK a radius of part 4′ of the distributor head 4. Diameters DA of the outflow channels 16 are smaller than a diameter DE of the intake channel 14, and thus have a smaller free flow area than the intake channel. See FIG. 3b.

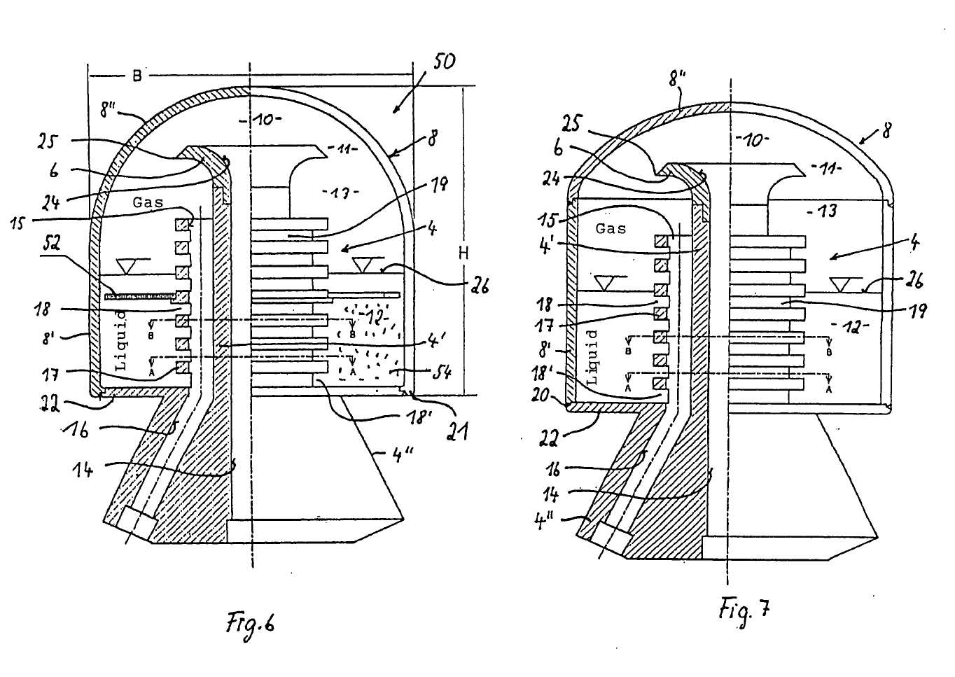

Cover 8 has a cylindrical mantle 8′ and a domed cover lid 8″, where mantle 8′ and cover lid 8″ are constructed, for example, as a single piece, see (FIG. 3), or from separate parts connected with one another (see FIG. 7). A rim 21 of mantle 8′ is connected with a ring flange 22 of the distributor head 4 with only one weld seam 20, where the weld seam may be underneath (FIG. 3) or on an external side (FIG. 7). The ring flange 22 is located on the boundary between parts 4′ and 4″ of the distributor head, approximately horizontally and tending outwards.

The intake cap 6 has a continually widening intake channel 24 in the direction of the central intake channel 14 of the distributor head 4, whose free rim 25 covers the intake openings 15 with an overhang, so that no liquid can enter the intake openings directly from above.

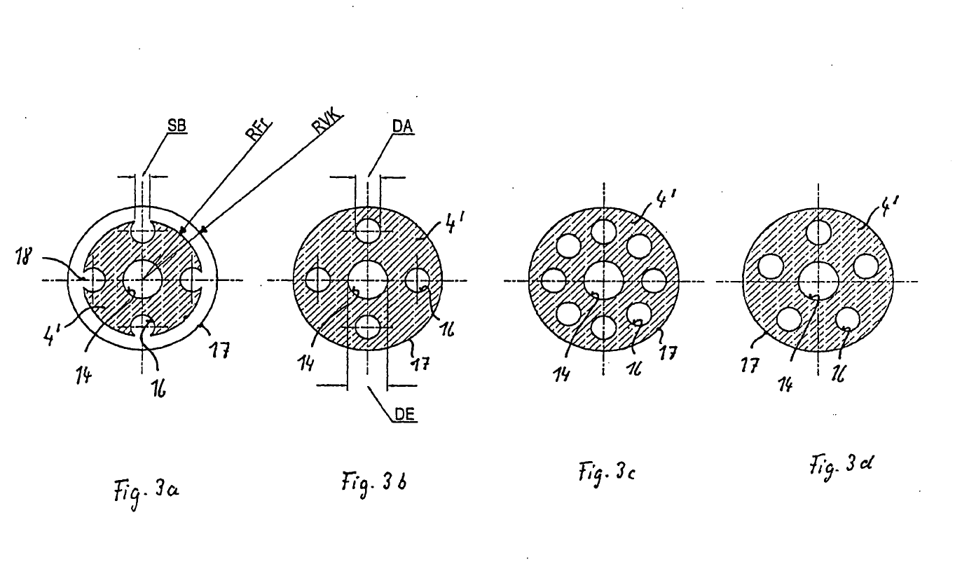

A height VKH and a diameter VKD of the cylindrical part 4′ of the distributor head 4, a height SH, the width and number of slits 18 of the outflow channel 16, the length, the diameter, and number of outflow channels 16, the length and diameter of the central intake channels 14, and the height H and diameter B of cover 8, may be varied as desired, see FIGS. 3 and 4a.

The functioning of coolant distributor 2 is as follows:

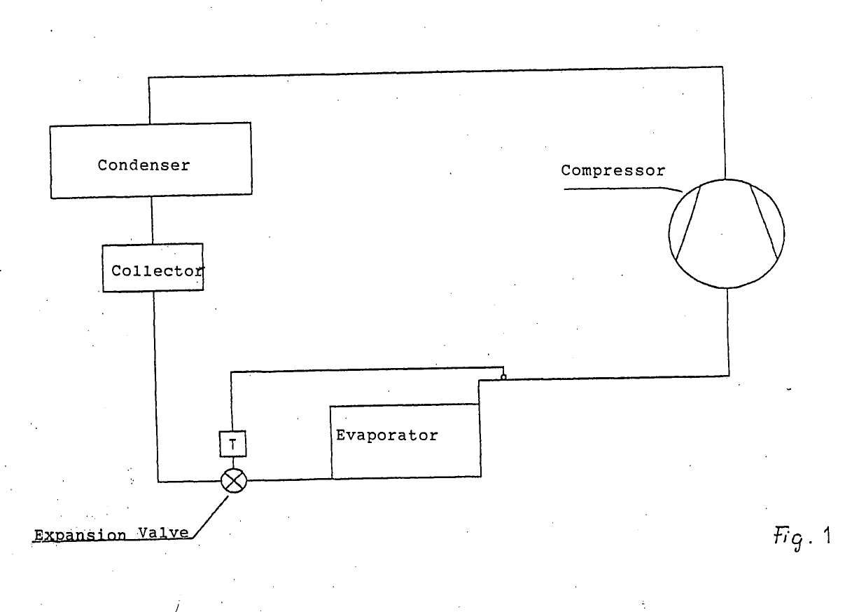

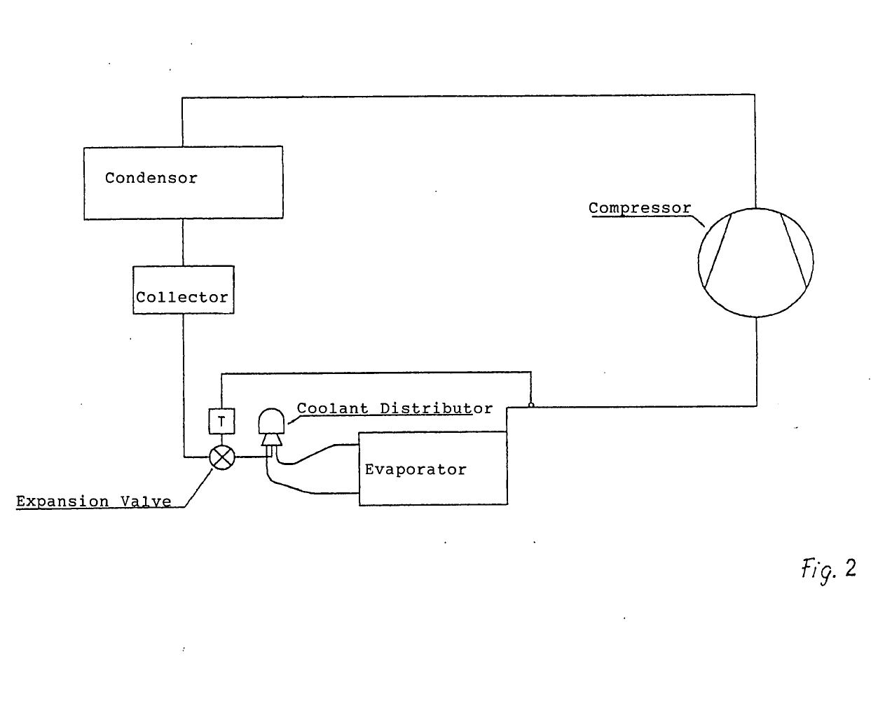

The gas/liquid mixture of the coolant flows from below into the vertical intake channel 14 constructed centrally in the distributor head 4, and flows out of the intake cap 6 to the intake control in the upper flow/guiding space 10. Cap 6 serves to reduce the flow rate and is an important stage for the unmixing, or separation, of the gas/liquid mixture of coolant coming from the expansion valve (see FIGS. 1 and 2). The flow leaving cap 6 strikes the upper domed part 8″ of cover 8 and flows over the upper flow space 10 and ring space 11 into the ring chamber 13 of the coolant distributor at a much reduced rate, which can be seen as a second separation stage. Then the flow reaches ring space 12 of coolant distributor 2 which has a larger volume and in which the final separation of the liquid phase from the gaseous phase of the coolant occurs. The liquid phase collects due to its specific volume in the lower part of ring space 12, and the gaseous phase remains in the upper part of ring space 12 and the ring chamber 13, see FIG. 3. The process of phase separation is by no means static, since everything occurs in the flow, which has its own unique stochastic dynamics.

As shown in FIGS. 3 and 3a-3d, the outflow occurs from the ring space 12 through the concentrically located round outflow channels 16 which run vertically in the upper part 4′ of the distributor head 4 and slanted outwards in the lower part 4″ of the distributor head 4. The number of outflow channels 16 corresponds to the number of evaporation paths in the evaporator.

The liquid portion of the coolant located in the lower part of ring space 12 flows through slits 18 into the outflow channels 16. The gaseous portion of the coolant located in the upper part of ring space 12 above a liquid level 26, is directed into the outflow channels 16 over the upper opening 15 of the outflow channels and from the side over slits 18.

In this way, an even or constant gas/liquid mixture of the coolant is ensured in the later parts of the channels, so that each evaporation path in the evaporator is supplied with an even or constant mass portion of gaseous and liquid coolant.

It is practical that (e.g., to achieve objects of the invention) the lowest slit 18′ may include a larger slit opening, which can be achieved by the provision, such as by milling, of a wider and/or deeper surrounding groove, so that dirt can flow out more easily and the danger of stopping up of the slit is avoided.

In order to influence the flow behavior positively and avoid turbulence, surrounding ribs 17 between the slit 18 can be suitably profiled and have rounded edges 29, for example, trapezoidally tapered on the outside with rounded edges 29, as shown in FIGS. 4a-4c.

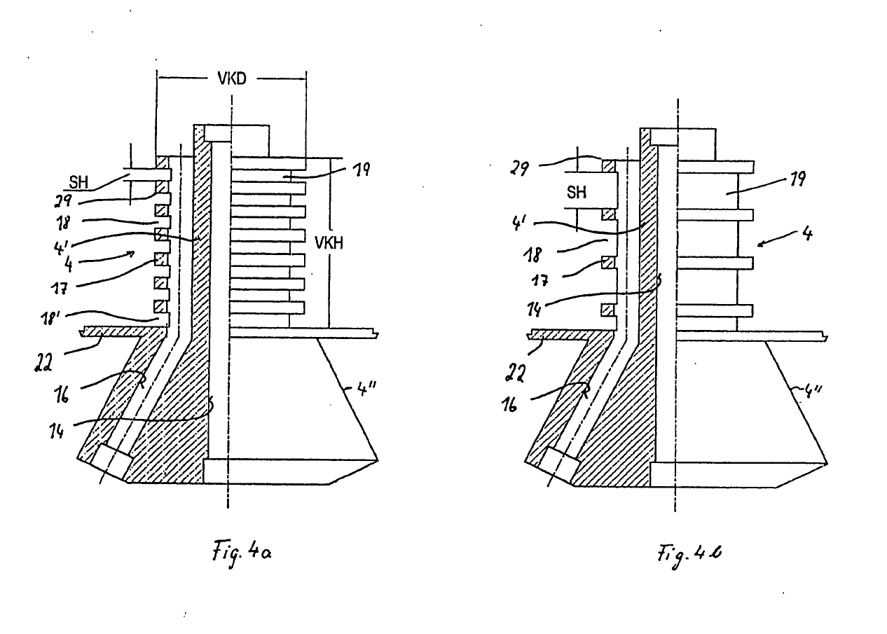

FIG. 5 shows a coolant distributor 30 which differs from coolant distributor 2 in FIG. 3 in that the central channels in a distributor head 32 and in a mushroom shaped cap 34 are absent, and a cover 36 has an upper intake nipple 38 with an intake channel 40 over which the gas/fluid mixture of the coolant from above into the coolant distributor 30 flows against a convex upper side 42 of the mushroom-shaped cap 34, whose edge 44(like the edge 25 of the embodiment of FIG. 3) covers the intake openings 15 of the outflow channels 16, and from which the flow is distributed radially and in a ring shape, analogous to the embodiment in FIG. 3. The intake nipple 38 and the insertably configured mushroom-shaped cap 34 may be configured, as desired, in accordance with the relevant flow conditions. The functioning of the coolant distributor 30 otherwise corresponds to the functioning of the coolant distributor 2 in FIG. 3.

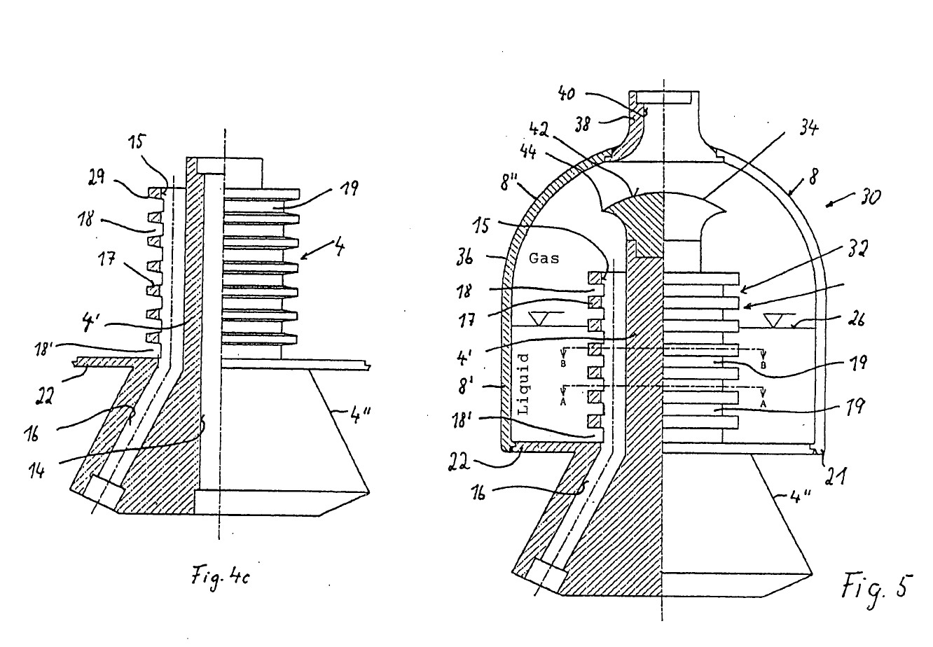

FIG. 6 shows a coolant distributor 50 which has substantially the same construction as the coolant distributor 2 in FIG. 3. It only has a ring-shaped sieve, screen, or otherwise perforated sheet wall 52 in the lower part of ring space 12 in which the liquid collects, which preferably ends with a small gap before the cover wall. Alternatively, or additionally, a permeable filling material 54, such as steel wool, may be inserted into the lower part of the ring space 12 (indicated with hatch marks). Either measure serves to calm the flow.

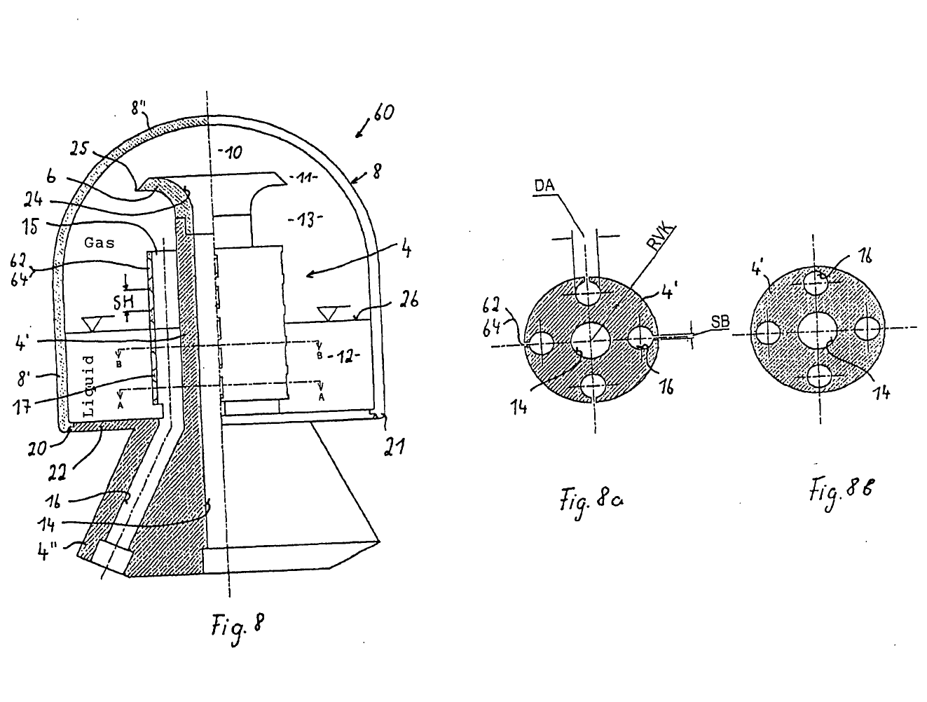

FIG. 8 shows a coolant distributor 60 which differs from coolant distributor 2 in FIG. 3 in that the passages of the FIG. 8 embodiment are vertical slits 62 or borings 64. FIGS. 8a and 8b show cross-sections A-A and B-B through the upper cylindrical part 4′ of distributor head 4 of FIG. 8. Otherwise coolant distributor 60 substantially corresponds to coolant distributor 2 in FIG. 3 in construction and function.

Distributor head 4 is manufactured by machining of stock, preferably of metal, or by casting.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Coolant distributor for use between an expansion valve and an evaporator of a cooling system, comprising:
a) a central fluid/gas mixture intake channel;
b) multiple outflow channels distributed around the intake channel with intake openings for a fluid and a gas;
c) a housing;
d) a flow space for directing radial flow;
e) a ring space between housing wall and outflow channels as a collection space for the fluid and the gas, and outflow channels in the channel walls having at least one passage connecting a fluid and gas region of the ring space with the channels; and
f) a one-piece distributor head being provided in which the outflow channels are machined, and which has a cap for intake control.

2. Coolant distributor as in claim 1, wherein:
a) the housing includes a cover connected to the distributor head, surrounding at least one part of the distributor head and the cap with a gap.

3. Coolant distributor as in claim 1, wherein:
a) the intake channel includes a cylindrical penetrating boring in the distributor head for directing a fluid/gas mixture from below, and having an opening ending with a gap at a cover wall in which cap is inserted, and which has a continually widening cap channel directed towards the intake channel.

4. Coolant distributor as in claim 1, wherein:
a) the intake channel includes an intake nipple on the top of one of the housing and the cover, for directing of the liquid/gas mixture from above, and
b) the cap includes a mushroom-shaped cap of the distributor head located below the intake channel and having a closed convex upper surface against which the fluid/gas mixture flows.

5. Coolant distributor as in claim 1, wherein:
a) a free rim of the cap covers the intake opening of the outflow channels with a gap.

6. Coolant distributor as claim 1, wherein:
a) the distributor head includes an upper cylindrical part on which the cap is inserted, and
b) a lower cone-shaped extension part.

7. Coolant distributor as in claim 1, wherein:
a) the outflow channels run parallel to the intake channel in the upper part of the distributor head and are slanted outwards in a lower part of the distributor head.

8. Coolant distributor as in claim 2, wherein:
a) the rim of the cover is connected with a ring flange of the distributor head.

9. Coolant distributor as in claim 8, wherein:
a) the ring flange is located at the boundary between part and part of the distributor head.

10. Coolant distributor as in claim 6, wherein:
a) at least one passage is located in a region of the outflow channel located in the upper cylindrical part.

11. Coolant distributor as in claim 10, wherein:
a) the passages include slits provided in surrounding grooves on the cylindrical part of the distributor head.

12. Coolant distributor as in claim 11, wherein:
a) the surrounding grooves are extended outwards.

13. Coolant distributor as in claim 11, wherein:
a) at least one rounded surrounding rib remains between the surrounding grooves.

14. Coolant distributor as in claim 10, wherein:
a) the passages are one of vertical slits and borings in the wall of the outflow channels next to the cylindrical part of the distributor head.

15. Coolant distributor as in claim 1, wherein:
a) the outflow channels have a smaller free flow area than the intake channel.

16. Coolant distributor as in claim 1, wherein:
a) the height and diameter of the cylindrical part of the distributor head, the height, width, and number of slits and the number and size of borings in the outflow channels, the length and diameter of the intake channel, and the height and width of the cover are variably selectable.

17. Coolant distributor as in claim 1, wherein:
a) a ring space is provided on the coolant distributor having a ring-shaped interior wall including one of a sieve-like, screen-like, and perforated plate material.

18. Coolant distributor as in claim 17, wherein:
a) the interior wall ends with a gap at the wall of one of the housing and cover.

19. Coolant distributor as in claim 17, wherein:
a) a permeable filling material is provided in the ring space.

20. Coolant distributor as in claim 19, wherein:
a) the filling material is metal wool.

21. Coolant distributor as in claim 1, wherein:
a) one of the interior wall and the filling material is provided in the fluid region of the ring space.

22. Coolant distributor as in claim 1, wherein:
a) the distributor head is manufactured by one of machining of stock and by using a casting technique.

23. Coolant distributor for use between an expansion valve and an evaporator of a cooling system, comprising:
a) a central fluid/gas mixture intake channel;
b) multiple outflow channels distributed around the intake channel with intake openings for a fluid and a gas;
c) a housing;
d) a flow space for directing radial flow;
e) a ring space between housing wall and outflow channels as a collection space for the fluid and the gas, and outflow channels in the channel walls having at least one passage connecting a fluid and gas region of the ring space with the channels;
f) a one-piece distributor head being provided in which the outflow channels are provided; and
g) a cap provided for intake control.

24. Coolant distributor as in claim 23, wherein:
a) the housing includes a cover connected to the distributor head, surrounding at least one part of the distributor head and the cap with a gap.

25. Coolant distributor as in claim 23, wherein:
a) the intake channel includes a cylindrical penetrating boring in the distributor head for directing a fluid/gas mixture from below, and having an opening ending with a gap at a cover wall in which cap is inserted, and which has a continually widening cap channel directed towards the intake channel.

26. Coolant distributor as in claim 23, wherein:
a) the intake channel includes an intake nipple on the top of one of the housing and the cover, for directing of the liquid/gas mixture from above, and
b) the cap includes a mushroom-shaped cap of the distributor head located below the intake channel and having a closed convex upper surface against which the fluid/gas mixture flows.

27. Coolant distributor as in claim 23, wherein:
a) a free rim of the cap covers the intake opening of the outflow channels with a gap.
